(19) United States
(12) Patent Application Publication
(10) Pub. No.: US 2003/0134193 A1
(43) Pub. Date: Jul. 17, 2003

(54) Closed type battery

(75) Inventors: Hiroshi Hanafusa, Utsunomiya-Shi (JP); Yasunobu Ooshima, Utsunomiya-Shi (JP)

Correspondence Address: ARMSTRONG,WESTERMAN & HATTORI, LLP, 1725 K STREET, NW, SUITE 1000, WASHINGTON, DC, 20006, US

(73) Assignee: NEC TOKIN Tochigi, Ltd., Utsunomiya-Shi (JP)

(21) Appl. No.: 10/335,939

(22) Filed: Jan. 3, 2003

(30) Foreign Application Priority Data
Jan. 9, 2002 (JP) 2002-002605

(51) Int. Cl. H01M 2/08; H01M 2/30

(52) U.S. Cl. 429/181; 429/184; 429/164; 429/161; 29/623.2; 29/623.4

(57) ABSTRACT

The invention provides a closed type battery comprising an electrode terminal formed by caulking a metal material mounted on a battery can via an insulating member with a different metal, wherein changes in contact resistance with years are reduced. In the electrode terminal, an electrode-drawing sheet mounted on the battery header through an insulating member is caulked integrally with an electrode-leading pin formed of a metal different from a metal forming the electrode-drawing sheet. A joint is provided by laser welding on at least one site on a surface portion of contact of the electrode-drawing sheet with the electrode-leading pin.

### BACKGROUND OF THE INVENTION

The present invention relates generally to a closed type battery assembled using a metal can as an outer casing member, and more particularly to a closed type battery characterized by an electrode terminal that is opposite in polarity to a battery can.

In lithium ion batteries used as power sources for portable equipments, flexible members such as synthetic resin films are used as outer casing materials for battery cans. Batteries using battery cans as outer casing members are now widely used because of being resistant to impacts from outside and excelling in sealing properties.

In a battery using a battery can as an outer casing member, the battery can is used as an electrode terminal of one polarity while another electrode terminal is formed on the outer casing member through an insulating member.

The electrode terminal opposite in polarity to the battery can is formed on a battery header that is mounted over an opening in the battery can. After a battery element is received in the battery can, a tab joined to the battery element is electrically connected to the electrode terminal of the battery header by means of resistance welding, laser welding or the like. Then, the battery header is mounted over the opening in the battery can and, finally, the junction of the wall surface of the battery can and the battery header is sealed up by means of laser welding or the like.

FIG. 4 is an upper sectional view illustrative of one example of the electrode terminal of a closed type battery.

A battery header 3 is mounted over an opening in the upper portion of a battery can 2 of a closed type battery 1, and a tab 5 that is connected to one electrode of a battery element 4 received in the battery can is joined to an electrode-leading pin 7 of an electrode terminal 6. The electrode-leading pin 7 is insulated from a metal sheet of the battery header by an outer insulating sheet 9 and an inner insulating sheet 10 mounted onto a through-hole formed through a metal sheet 8 of the battery header 3. On the upper surface of the outer insulting sheet there is provided an electrode-drawing sheet 11 that is formed of a nickel or other material having satisfactory joining properties in such a way that a lead wire for external circuit connection can easily be joined thereto.

The electrode terminal is produced by attaching an external insulating sheet, an internal insulating sheet and an electrode-drawing sheet onto a through-hole formed through a metal sheet, inserting an electrode-leading pin through the assembly from the internal insulating sheet side, and caulking the electrode-leading pin.

The surface of contact of the electrode-leading pin formed of aluminum or its alloy with the electrode-drawing sheet changes with years due to penetration of atmospheric air, moisture, etc., and consequently, the conductivity of the surface portion of contact becomes low.

One object of the present invention is to make improvements in the contact resistance of an electric connection formed only by contact of different metals, and another object of the invention is to provide a closed type battery that is protected against an increase in the contact resistance of a portion of contact due to changes with years.

### BRIEF DESCRIPTION OF THE DRAWINGS

FIG. 1 is illustrative in section of an electrode terminal portion of the closed type battery according to the invention.

FIG. 2 is illustrative of the composition of the joint.

FIG. 3 is illustrative on one example of the pattern for irradiation with laser beams.

FIG. 4 is illustrative of one example of the electrode terminal of a closed type battery.

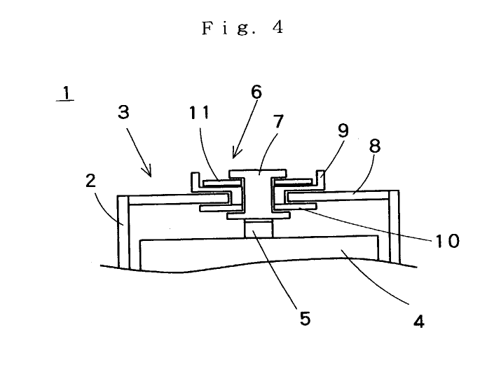

### SUMMARY OF THE INVENTION

The present invention provides a closed type battery comprising a battery can, a battery header mounted over an opening in the battery can, and an electrode terminal in which an electrode-drawing sheet mounted on the battery header through an insulating member is caulked integrally with an electrode-leading pin formed of a metal different from a metal forming the electrode-drawing sheet, wherein:

a joint is provided by laser welding on at least one site on a surface portion of contact of the electrode-drawing sheet with the electrode-leading pin.

Preferably in the aforesaid closed type battery, the electrode-leading pin is formed of aluminum or an alloy thereof, and the electrode-drawing sheet is formed of a metal or an alloy thereof different in melting point from aluminum or the alloy thereof.

Preferably in the aforesaid closed type battery, the electrode-drawing sheet is formed of nickel or an alloy thereof, iron or an alloy thereof, copper or an alloy thereof, or stainless steel.

The present invention also provides a closed type battery fabrication process, comprising steps of:

forming an electrode terminal in which an electrode-drawing sheet mounted via an insulting member on a battery header mounted over an opening in a battery can is caulked integrally with an electrode-leading pin formed of a metal different from a metal forming the electrode-drawing sheet, and then forming by laser welding a joint on at least one site on a surface portion of contact of the electrode-leading pin with the electrode-drawing sheet.

Preferably in the aforesaid fabrication process, the laser welding is carried out by successive stages of preheating by laser at a given output, melting of the joint by laser at a given output, and prevention by laser at a given output of cracking on solidification, wherein said given outputs differ from one another.

### DESCRIPTION OF THE PREFERRED EMBODIMENT

According to the present invention, a part of the surface portion of contact of an electrode-leading pin formed of aluminum with an electrode-drawing sheet formed of another metal sheet having a melting point largely different from that of aluminum, for instance, a nickel sheet is joined together by laser welding.

It has thus been found that even when, as is the case with an aluminum sheet and a nickel sheet, no sufficient strength is obtained between both sheets due to the formation of an intermetallic compound, the electrical connection of the junction between both can be maintained in a stable manner with no change with years.

The present invention is now explained specifically with reference to the accompanying drawings.

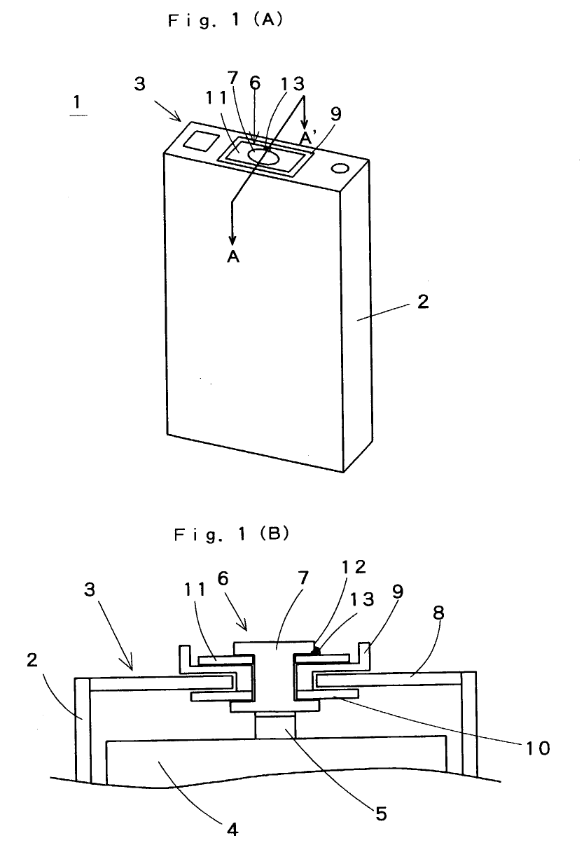

FIG. 1 is illustrative in section of an electrode terminal portion of the closed type battery according to the invention.

FIG. 1(A) is a perspective view of the closed type battery according to the invention, and FIG. 1(B) is a sectional view of an upper portion of the closed type battery.

A battery header 3 is mounted over an opening in a battery can 2 of a closed type battery 1, and a tab 5 connected to one electrode of a battery element received in the battery can is joined to an electrode-leading pin 7 of an electrode terminal 6. The electrode-leading pin 7 formed of aluminum is insulated from a metal sheet of the battery head by means of an external insulating sheet 9 and an inner insulating sheet 10 mounted onto a through-hole formed through a metal sheet 8 of the battery header 3. On the upper surface of the external insulating sheet, there is provided an electrode-drawing sheet 11 formed of nickel, to which an external circuit connection lead wire is joined.

On a portion of contact of the electrode-drawing sheet 11 with a peripheral area 12 formed by caulking the surface of the electrode-drawing sheet 11 with the electrode-leading pin 7, there is provided a joint 13 formed of a nugget comprising nickel and aluminum by irradiation with laser beams.

The number of such a joint should preferably be one, because the joint 13 formed on the site of contact of the electrode-leading sheet 11 with the electrode-drawing sheet 7 contributes to conduction together with an electrical connection on the surface of contact of the electrode-leading pin with the electrode-drawing sheet. The size of the joint should preferably be about 0.6 mm in diameter, at which sufficient currents can pass. When a plurality of joints are provided, they must be located in such a way that there is no warp in the electrode terminal.

When the nugget is irradiated with laser beams, it is preferable to enter laser beams at the interface between nickel and aluminum, thereby fully melting them at the joint. However, since aluminum or its alloy is largely different in melting point from nickel or its alloy, it is difficult to form a cracking-free joint only by melting both simply.

Thus, it is of importance to irradiate the joint nugget with laser beams according to a given pattern. First, the joint nugget is irradiated with a laser beam at a low output for a given time, so that the joint nugget is preheated. Then, the joint nugget is welded by irradiation with a laser beam at an output enough to melt both. Finally, the joint nugget is irradiated with a laser beam at an output lower than that for welding, so that cracking on solidification is prevented. By controlling the irradiation time and output in such a three-stage manner, it is preferable to fully melt nickel and aluminum to form the joint while the joint is kept from cracking.

While the present invention has been described with reference to the electrical connection pin formed of aluminum or its alloy and the electrode-drawing sheet formed of nickel (having a melting point of 1,455° C.), it is understood that the present invention is similarly applicable to the welding of an electrical connection pin formed of aluminum (having a melting point of about 660° C.) or its alloy to an electrode-drawing sheet formed of iron (having a melting point of 1,535° C.), copper (having a melting point of 1,083° C.), stainless steel similar in melting point to iron or the like.

The present invention is now explained more specifically with reference to Example 1 and Comparative Example 1 wherein electrode-leading pins of aluminum and electrode-drawing sheets of nickel are used.

### EXAMPLE 1

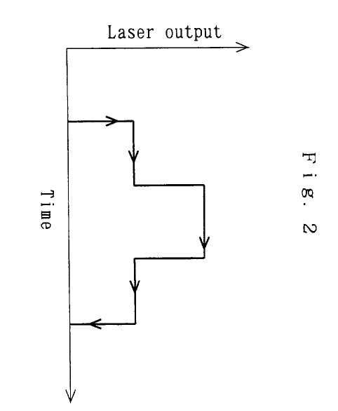

An electrode terminal was prepared by caulking a nickel electrode-drawing sheet of 3 mm in width, 9 mm in length and 0.3 mm in thickness with an aluminum electrode-leading pin of 3 mm in diameter. One site of the interface between the electrode-leading pin and the electrode-drawing sheet of the electrode terminal was irradiated with laser beams according to the pattern of FIG. 2, using an optical fiber of 0.3 mm in diameter. That is, the joint was formed through the successive stages of preheating at an output of 1.4 kW for an irradiation time of 1 ms, welding at an output of 3 kW for an irradiation time of 1.5 ms, and prevention of cracking on solidification at an output of 1.4 kW for an irradiation time of 1 ms.

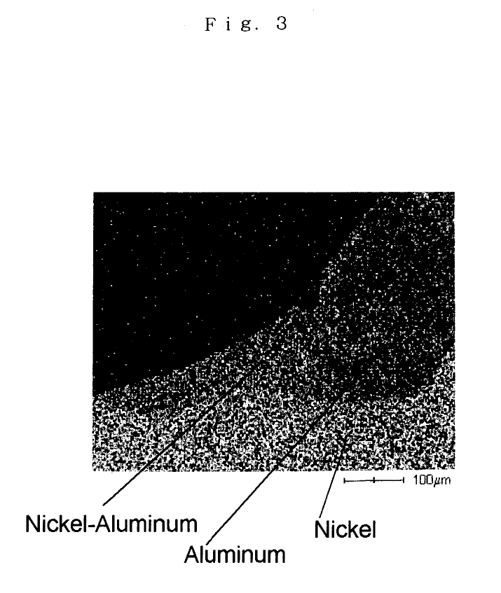

The results of mapping analysis for elements of the joint by X-ray microanalyzer are shown in FIG. 3. It has been found that both aluminum and nickel are uniformly distributed through the joint.

The thus prepared battery samples 1 to 5 were measured for the contact resistance between the electrode-leading pin and the electrode-drawing sheet just after preparation. Thereafter, these samples were subjected to accelerated tests wherein they were stored for 7 days at 85° C. and 90% RH to measure their contact resistance. The results are tabulated below.

### COMPARATIVE EXAMPLE 1

Battery samples 6 to 10 were prepared as in Example 1 with the exception that no joint was formed by laser welding. As in Example 1, the impedances of the portions of contact were measured just after preparation and after accelerated testing. The results are tabulated below.

TABLE 1

| | | Laser Welded | | | | | Not Laser Welded | | | | |
|---|---|---|---|---|---|---|---|---|---|---|---|
| Sample | | 1 | 2 | 3 | 4 | 5 | 6 | 7 | 8 | 9 | 10 |
| (A) | (Ω) | 0.37 | 0.41 | 0.38 | 0.34 | 0.37 | 0.36 | 0.34 | 0.41 | 0.39 | 0.38 |
| (B) | (Ω) | 0.37 | 0.37 | 0.48 | 0.46 | 0.35 | 1.24 | 1.60 | 1.26 | 0.74 | 1.34 |

(A) just after preparation
(B) after accelerated testing

According to the present invention so far explained, there is provided a closed type battery having an electrode terminal formed by caulking, wherein a joint is formed by laser welding on a portion of contact between different metals having largely different melting points. It is thus possible to prevent the properties of an electrical connection on the surface of contact from becoming worse due to changes with years and, hence, provide a closed type battery having stable properties.

What we claim is:

1. A closed type battery comprising a battery can, a battery header mounted over an opening in the battery can, and an electrode terminal in which an electrode-drawing sheet mounted on the battery header through an insulating member is caulked integrally with an electrode-leading pin formed of a metal different from a metal forming the electrode-drawing sheet, wherein:
a joint is provided by laser welding on at least one site on a surface portion of contact of the electrode-leading pin with the electrode-drawing sheet.

2. The closed type battery according to claim 1, wherein the electrode-leading pin is formed of aluminum or an alloy thereof, and the electrode-drawing sheet is formed of a metal or an alloy thereof different in melting point from aluminum or the alloy thereof.

3. The closed type battery according to claim 2, wherein the electrode-drawing sheet is formed of at least one metal selected from the group consisting of nickel or an alloy thereof, iron or an alloy thereof, copper or an alloy thereof, and stainless steel.

4. A closed type battery fabrication process, comprising steps of:
forming an electrode terminal in which an electrode-drawing sheet mounted via an insulting member on a battery header mounted over an opening in a battery can is caulked integrally with an electrode-leading pin formed of a metal different from a metal forming the electrode-drawing sheet, and then forming by laser welding a joint on at least one site on a surface portion of contact of the electrode-leading pin with the electrode-drawing sheet.

5. The closed type battery fabrication process according to claim 4, wherein the laser welding is carried out by successive stages of preheating by laser at a given output, melting of the joint by laser at a given output, and prevention by laser at a given output of cracking on solidification, wherein said given outputs differ from one another.
